(19) United States
(12) Patent Application Publication
(10) Pub. No.: US 2025/0023024 A1
(43) Pub. Date: Jan. 16, 2025

(54) NEGATIVE ELECTRODE MATERIAL, NEGATIVE ELECTRODE PLATE AND BATTERY

(71) Applicant: ZHUHAI COSMX BATTERY CO., LTD., Zhuhai (CN)

(72) Inventors: Liuqing HE, Zhuhai (CN); Guanzheng WU, Zhuhai (CN); Feng WANG, Zhuhai (CN); Suli LI, Zhuhai (CN); Junyi LI, Zhuhai (CN)

(73) Assignee: ZHUHAI COSMX BATTERY CO., LTD., Zhuhai (CN)

(21) Appl. No.: 18/896,868

(22) Filed: Sep. 25, 2024

Related U.S. Application Data
(63) Continuation-in-part of application No. PCT/CN2023/123816, filed on Oct. 10, 2023.

(30) Foreign Application Priority Data
Nov. 14, 2022 (CN) 202211419237.4

(51) Int. Cl. H01M 4/36; H01M 4/02; H01M 4/38; H01M 4/583; H01M 4/60

(52) U.S. Cl. CPC H01M 4/366; H01M 4/386; H01M 4/583; H01M 4/60; H01M 2004/021; H01M 2004/027

(57) ABSTRACT

Disclosed are a negative electrode material, a negative electrode plate including the negative electrode material and a battery including the negative electrode material. The negative electrode material includes an MOF@ carbon composite material and a silicon-based material. The negative electrode material of the present disclosure has good flexibility and scalability, which not only solves a problem of expansion of the negative electrode material in a battery charging process, but also enables the negative electrode to keep good electrical contact all the time in a battery discharging and shrinkage process.

### CROSS-REFERENCE TO RELATED APPLICATIONS

The present disclosure is a continuation-in-part of International Application No. PCT/CN2023/123816, filed on Oct. 10, 2023, which claims priority to Chinese Patent Application No. 202211419237.4, filed on Nov. 14, 2022. Both of the aforementioned applications are hereby incorporated by reference in their entireties.

### TECHNICAL FIELD

The present disclosure relates to the field of batteries, and specifically, to a negative electrode material, a negative electrode plate including the negative electrode material and a battery including the negative electrode material.

### BACKGROUND

Energy crisis and environmental pollution jointly threaten the survival and development of human society, and new energy development is imminent. Energy storage devices such as batteries play an important role in energy storage and release, and thus become the focus of new energy. Lithium-ion batteries have attracted the most attention because of high open-circuit voltage, high energy density, long service life, no memory effect, no pollution and low self-discharge rate thereof.

In the development of battery materials, negative electrode materials have gained great attention and research. A theoretical specific capacity of a commercial graphite negative electrode is 372 mAhg⁻¹, while a theoretical specific capacity of silicon reaches 4,200 mAhg⁻¹. New negative electrode materials can increase the capacity by more than 10 times, but also bring huge volume change, which causes pulverization damage of the negative electrode materials and leads to a sharp decline in the capacity during cycling. Metal-organic framework material (MOF) has potential values in solving an expansion problem of negative electrode materials due to an advantage of easy functionalization with other heteroatoms or metals and metal oxides thereof. In the conventional technology, the MOF is used to modify a silicon material/carbon material/silicon-carbon composite material to be used as a negative electrode material, but there are the following problems: when the negative electrode material during lithium intercalation, the MOF cannot completely buffer volume expansion of the negative electrode material, and excessive volume expansion directly leads to collapse of an MOF framework, resulting in poor structure of a formed lithium ion battery; and when the negative electrode material during lithium deintercalation, loose pores of the MOF make it difficult for the negative electrode to maintain good electrical contact all the time during the working process.

Therefore, it is necessary to develop a negative electrode material having a large capacity and a small volume expansion rate.

### SUMMARY

The objective of the present disclosure is to overcome the problems in a conventional technology by providing a negative electrode material and an electrode plate, a negative electrode plate including the negative electrode material and a battery including the negative electrode material. The negative electrode material of the present disclosure has good flexibility and scalability, which not only solves a problem of expansion of the negative electrode material in a battery charging process, but also enables the negative electrode to keep good electrical contact all the time in a battery discharging and shrinkage process.

The inventors of the present disclosure have found that using MOF with a flexible framework structure to modify a carbon material can effectively alleviate expansion of the negative electrode material and can always maintain good electrical contact during the working process of the negative electrode, and the reason may be that: the MOF with the flexible framework can undergo large-amplitude reversible deformation, that is, under the stimulation of surrounding environmental factors (such as temperature, pressure, and the like), the framework structure of the MOF can be converted between two forms of “macropore” and “micropore”, and accordingly, a cell volume of the MOF changes greatly. In the initial state, the MOF with the flexible framework structure exists in the form of “macropore”. During the charging process, lithium ions are intercalated in the negative electrode, and the volume of the negative electrode expands. In this case, an external pressure increases. Under the stimulation of the pressure, the MOF with the flexible framework changes from the form of “macropore” to the form of “micropore”, and the cell volume thereof is greatly reduced. The reduced volume of the MOF with the flexible framework can be counteracted with the expanded volume of the negative electrode, so that the overall volume change of the negative electrode is not large; in the discharging process, the lithium ions are deintercalated from the negative electrode, and the volume of the negative electrode shrinks; in this case, the external pressure returns to normal, the MOF with the flexible framework is converted from the “micropore” form to the “macropore” form, the cell volume of the MOF is restored to that in the initial state, and in the discharging process of the battery, the volume of the negative electrode always changes little, which allows the negative electrode to always maintain good electrical contact.

A first aspect of the present disclosure provides a negative electrode material, and the negative electrode material includes an MOF@ carbon composite material and a silicon-based material.

A second aspect of the present disclosure provides a negative electrode plate, and the negative electrode plate includes the negative electrode material according to the first aspect of the present disclosure.

A third aspect of the present disclosure provides a battery, and the battery includes the negative electrode material according to the first aspect of the present disclosure and/or the electrode plate according to the second aspect of the present disclosure.

Based on the foregoing technical solutions, the present disclosure has at least the following advantages over the conventional technology.

Firstly, the negative electrode material of the present disclosure includes the MOF@ carbon composite material and the silicon-based material, the MOF@ carbon composite material has a flexible framework structure, and has good scalability, so that the negative electrode material can not only relieve the volume expansion of the negative electrode during the battery charging process, but also provide more active sites for intercalation and deintercalation of lithium ion,

Secondly, the negative electrode material of the present disclosure includes the MOF@ carbon composite material and the silicon-based material, which enables the negative electrode to keep good electrical contact all the time in the battery discharging and shrinkage process.

An endpoint and any value of the ranges disclosed herein are not limited to the exact ranges or values, and these ranges or values shall be understood to include values close to these ranges or values. For a numerical range, one or more new numerical ranges may be obtained in combination with each other between endpoint values of respective ranges, between endpoint values of respective ranges and individual point values, and between individual point values, and these numerical range should be considered as specifically disclosed herein.

### BRIEF DESCRIPTION OF THE DRAWINGS

FIG. 1a is a schematic structural diagram of an MOF according to an example of the present disclosure.

FIG. 1b is a schematic structural diagram of an MOF according to an example of the present disclosure.

FIG. 1c is a schematic structural diagram of an MOF according to an example of the present disclosure.

FIG. 1d is a schematic structural diagram of an MOF according to an example of the present disclosure.

FIG. 1e is a schematic structural diagram of an MOF according to an example of the present disclosure.

FIG. 1f is a schematic structural diagram of an MOF according to an example of the present disclosure.

FIG. 2 is an X-ray diffraction (XRD) pattern of MIL-47(V)@ graphene oxide obtained in Example 1.

FIG. 3 is a scanning electron microscope (SEM) image of the MIL-47(V)@ graphene oxide obtained in Example 1.

FIG. 4 is a comparison diagram of a cycling capacity retention rate of a battery prepared by a negative electrode plate obtained in Example 1 and a capacity retention rate of a battery prepared by a negative electrode plate obtained in Comparative Example 2.

FIG. 5 is a schematic diagram of a preparation method of the MIL-47(V)@ graphene oxide obtained in Example 1.

### DETAILED DESCRIPTION OF THE EMBODIMENTS

Specific implementations of the present disclosure are described below in detail. It should be understood that the specific implementations described herein are merely used for the purposes of illustrating and explaining the present disclosure, rather than limiting the present disclosure.

A first aspect of the present disclosure provides a negative electrode material, and the negative electrode material may include an MOF@ carbon composite material and a silicon-based material.

In the present disclosure, the MOF@ carbon composite material includes an MOF and a carbon material.

In the present disclosure, the MOF@ carbon composite material is an MOF-modified carbon material. For example, the MOF-modified carbon material is an MOF-coated carbon material. For another example, the MOF-modified carbon material is an MOF-doped carbon material.

In an example, the MOF has a flexible framework structure.

In the present disclosure, the term “MOF” has a conventional meaning in the art. The term “MOF” refers to a metal-organic framework material.

In an example, the MOF@ carbon composite material includes the MOF-coated carbon material.

In an example, the MOF@ carbon composite material is the MOF-coated carbon material.

The MOF is formed by assembling an organic ligand and a metal ion by means of a chemical self-assembly process; that is, the MOF includes a moiety derived from the organic ligand and a moiety derived from the metal ion; or, the MOF is composed of the organic ligand and the metal ion by means of a coordination bond. For example, the metal ion may be selected from at least one of Fe³⁺, Al³⁺, Co²⁺, V⁵⁺, Ti⁴⁺, Zn²⁺, Cu²⁺, Cr³⁺, Mn²⁺, or Ni²⁺. The organic ligand may be selected from at least one of terephthalic acid, 2-aminoterephthalic acid, biphenyl-4,4′-dicarboxylic acid, 1,4-Di (1H-pyrazol-4-yl) benzene, 4,4′-Dipyridyl, 4,4′-Carbonyldiphthalic acid, or 1,4-Diazabicyclo[2.2.2]octane.

In an example, the MOF includes a metal element, and the metal element is selected from at least one of Fe, Al, Co, V, Ti, Zn, Cu, Cr, Mn, or Ni.

In the present disclosure, a mass of the metal element accounts for 0.72% to 7.8% of a total mass of the negative electrode material, for example, 0.72%, 0.8%, 0.9%, 1%, 2%, 3%, 4%, 5%, 6%, 7%, or 7.8%.

In an example, the mass of the metal element accounts for 0.8% to 6.2% of the total mass of the negative electrode material.

The inventors of the present disclosure have found that specific metal elements have strong stability (i.e., resistance to electrolyte solution corrosion) in an electrolyte solution environment and strong electrochemical reduction resistance, and are not easy to be reduced at the negative electrode to make the framework structure collapse. In addition, the specific metal elements can form strong coordination bonds with organic ligands, which directly affect the stability of the formed flexible framework structure. The inventors of the present disclosure have further found that when the mass of the metal element accounts for too high the total mass of the negative electrode material, a capacity and conductivity of the battery may be reduced, thus affecting a polarization performance of the battery. However, when the mass of the metal element accounts for too little of the total mass of the negative electrode material, an expansion rate of the battery may be too high, thus affecting a cycling performance of the battery.

In an example, the MOF is selected from at least one of MIL-47(V), NH₂-MIL-53(Al), DUT-5(Al), Co(BDP), Zn₂(btdc)₂(bpy), or Zn₂(1,4-bdc)₂(dabco).

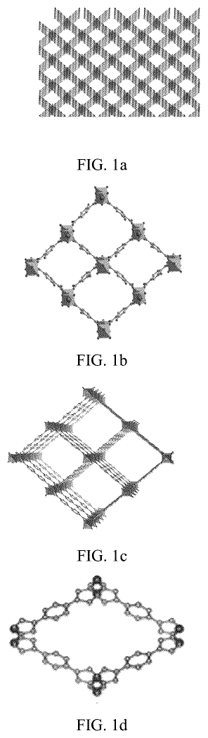

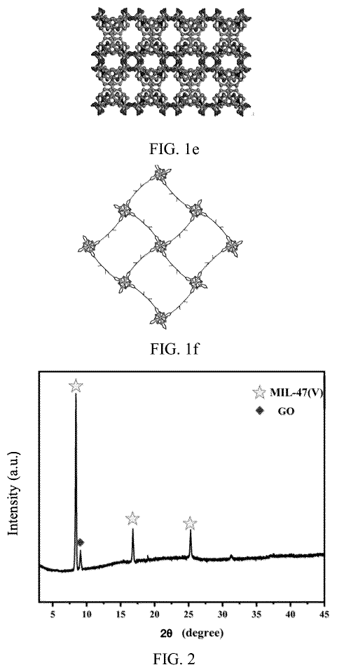

FIG. 1a to FIG. 1f are all schematic structural diagrams of the MOF in an example of the present disclosure, where FIG. 1a is a schematic structural diagram of MIL-47(V), FIG. 1b is a schematic structural diagram of NH₂-MIL-53(Al), FIG. 1c is a schematic structural diagram of DUT-5(Al), FIG. 1d is a schematic structural diagram of Co(BDP), FIG. 1e is a schematic structural diagram of Zn₂(btdc)₂(bpy), and FIG. 1f is a schematic structural diagram of Zn₂(1,4-bdc)₂(dabco).

The inventors of the present disclosure have found that, when the organic ligand contains a benzene ring structure, lithium ions may be partially intercalated in the benzene ring of the organic ligand of the MOF channel during the charging process of the battery, which can further improve the capacity performance of the battery.

In an example, the organic ligand contains a benzene ring.

The inventors of the present disclosure have found that, an organic ligand of MIL-47(V) is a terephthalic acid, which contains a benzene ring structure, and MIL-47(V) has a large volume change rate (about 40%), which can effectively improve the capacity performance and cycling performance of the battery.

In an example, the MOF is MIL-47(V).

In an example, in an XRD pattern of the MOF, characteristic peaks occur at 8.2° to 8.8°, 16.3° to 17.3°, and 24.5° to 25.5°.

In an example, the MOF is a combination of MIL-47(V) with at least one of NH₂-MIL-53(Al), DUT-5(Al), Co(BDP), Zn₂(btdc)₂(bpy), or Zn₂(1,4-bdc)₂(dabco).

The MOF with the flexible framework structure has a certain degree of spatial freedom because of a special pore structure thereof, and the framework structure thereof can undergo large-scale reversible deformation, that is, under the stimulation of an external environment (such as temperature and pressure and the like), the framework structure of the MOF can be converted between two forms of “macropore” and “micropore”, and accordingly, a cell volume of the MOF also changes greatly. Taking the MIL-47(V) as an example, the volume change rate thereof is as high as 40%.

In the present disclosure, the volume change rate of the MOF may range from 20% to 60%, for example, 20%, 21%, 27%, 30%, 36%, 40%, 45%, 50%, 59%, or 60%.

The inventors of the present disclosure have found that, when the volume change rate of the MOF is within a specific range, the battery can have both high capacity and low expansion rate.

In the present disclosure, the volume change rate of the MOF may be obtained by a Monte Carlo (MC) simulation method.

In the present disclosure, the silicon-based material includes at least one of silicon, silicon carbon, or SiOₓ (0<x<2). The silicon may include nano-silicon. The SiOₓ (0<x<2) may include nano-silicon monoxide.

In an example, the silicon-based material is nano-silicon.

In an example, a median particle size Dv50 of the silicon-based material may range from 100 nm to 400 nm, for example, 100 nm, 150 nm, 200 nm, 250 nm, 300 nm, 350 nm, or 400 nm.

The inventors of the present disclosure have found that, when the median particle size Dv50 of the silicon-based material is too small, a specific surface area of the silicon-based material is too large, so that attenuation is accelerated, and a stability of the material is also reduced; and when the median particle size Dv50 of the silicon-based material is too large, an electrical contact is reduced, and a bulk density is reduced, so that an energy density of the battery is reduced, and relaxation is increased.

A median particle size Dv50 of the MOF@ carbon composite material may range from 100 nm to 400 nm, for example, 100 nm, 150 nm, 200 nm, 250 nm, 300 nm, 350 nm, or 400 nm.

The inventors of the present disclosure have found that, when the median particle size Dv50 of the MOF@ carbon composite material is too small, a specific surface area of the MOF@ carbon composite material is too large, so that attenuation is accelerated, and a stability of the material is also reduced; and when the median particle size Dv50 of the MOF@ carbon composite material is too large, an electrical contact is reduced, and a bulk density is reduced, so that an energy density of the battery is reduced, and relaxation is increased.

A median particle size Dv50 of the negative electrode material may range from 100 nm to 400 nm, for example, 100 nm, 150 nm, 200 nm, 250 nm, 300 nm, 350 nm, or 400 nm.

The inventors of the present disclosure have found that, when the median particle size Dv50 of the negative electrode material is too small, a specific surface area of the negative electrode material is too large, so that attenuation is accelerated, and a stability of the material is also reduced; and when the median particle size Dv50 of the negative electrode material is too large, an electrical contact is reduced, and a bulk density is reduced, so that an energy density of the battery is reduced, and relaxation is increased.

In the present disclosure, the median particle size Dv50 of the MOF@ carbon composite material, the median particle size Dv50 of the silicon-based material, and the median particle size Dv50 of the negative electrode material may be measured by a laser diffraction particle sizer, specifically referring to the national standard GB/T 24533-2019 Graphite Negative Electrode Materials for Lithium Ion Batteries for details.

In the present disclosure, the carbon material may be selected from a conventional carbon material in the art, for example, selected from at least one of a graphene material, a carbon nanotube, carbon black, soft carbon, hard carbon, or graphite. The graphene material may be graphene and graphene oxide. The carbon nanotube may be a single-walled carbon nanotube and a multi-walled carbon nanotube.

The inventors of the present disclosure have found that, when the carbon material is graphene oxide, the conductivity and the stability of the negative electrode material are more excellent, and the reason may be that: carboxyl and hydroxyl groups of the graphene oxide can coordinate with the metal ions of the MOF, which strengthens contact between the MOF and graphite particles, facilitates the lithium ion insertion and extraction, and improves the electrochemical capacity performance and stability.

In an example, the carbon material includes graphene oxide.

In an example, the carbon material is graphene oxide.

In an example, in an XRD pattern of the carbon material, characteristic peaks occur at 8.5° to 9.5°.

Based on a total weight of the negative electrode material, a content of the MOF@ carbon composite material may range from 16 wt % to 26 wt % (for example, 16 wt %, 17 wt %, 18 wt %, 19 wt %, 20 wt %, 21 wt %, 22 wt %, 23 wt %, 24 wt %, 25 wt %, or 26 wt %), and a content of the silicon-based material may range from 74 wt % to 84 wt % (for example, 84 wt %, 83 wt %, 82 wt %, 81 wt %, 80 wt %, 79 wt %, 78 wt %, 77 wt %, 76 wt %, 75 wt %, or 74 wt %).

In an example, based on the total weight of the negative electrode material, the content of the MOF@ carbon composite material ranges from 19 wt % to 22 wt %, and the content of the silicon-based material ranges from 78 wt % to 81 wt %.

In an example, based on the total weight of the negative electrode material, the content of the MOF@ carbon composite material ranges from 19.5 wt % to 20.5 wt %, and the content of the silicon-based material ranges from 79.5 wt % to 80.5 wt %.

Based on a total weight of the MOF@ carbon composite material, the content of the MOF may range from 80 wt % to 99.9 wt % (for example, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, or 99.9 wt %), and the content of the carbon material may range from 0.1 wt % to 20 wt % (for example, 20 wt %, 19 wt %, 18 wt %, 17 wt %, 16 wt %, 15 wt %, 14 wt %, 13 wt %, 12 wt %, 11 wt %, 10 wt %, 9 wt %, 8 wt %, 7 wt %, 6 wt %, 5 wt %, 4 wt %, 3 wt %, 2 wt %, 1 wt %, or 0.1 wt %).

The inventors of the present disclosure have found that, in the MOF@ carbon composite material, the MOF and the carbon material have specific contents, so that the MOF@ carbon composite material can give consideration to large deformation and good electrical contact performance.

In an example, based on the total weight of the MOF@ carbon composite material, the content of the MOF ranges from 90 wt % to 99 wt %, and the content of the carbon material ranges from 1 wt % to 10 wt %.

A ratio of a mass proportion of the MOF in the negative electrode material to a mass proportion of the silicon-based material in the negative electrode material may range from 1:3.1 to 1:5.5, for example, 1:3.1, 1:3.5, 1:4, 1:4.5, 1:5, or 1:5.5.

The inventors of the present disclosure have found that, the mass proportion of the MOF in the negative electrode material and the mass proportion of the silicon-based material in the negative electrode material have a specific ratio, so that the MOF can alleviate the volume expansion of the silicon-based material and keep the volume of the negative electrode material from abrupt change.

In an example, the ratio of the mass proportion of the MOF in the negative electrode material to the mass proportion of the silicon-based material in the negative electrode material ranges from 1:3.8 to 1:4.6.

In an example, the ratio of the mass proportion of the MOF in the negative electrode material to the mass proportion of the silicon-based material in the negative electrode material ranges from 1:4 to 1:4.5.

The negative electrode material of the present disclosure includes the MOF@ carbon composite material and the silicon-based material, the MOF@ carbon composite material is the MOF-modified carbon material, and the MOF has good scalability, which can provide more active sites for intercalation and deintercalation of lithium ion, can relieve the volume expansion of the negative electrode during the battery charging process, and enables the negative electrode to keep good electrical contact all the time in the battery discharging and shrinkage process.

A second aspect of the present disclosure provides a negative electrode plate, and the negative electrode plate includes the negative electrode material according to the first aspect of the present disclosure.

The negative electrode plate includes a negative electrode current collector and a coating on either or both sides of the negative electrode current collector, and the coating includes the negative electrode material according to the first aspect of the present disclosure.

The coating may further include additives conventionally used for coatings, such as a conductive agent and a binder.

In an example, the coating includes the negative electrode material, a conductive agent and a binder. The conductive agent may include at least one of Super P, acetylene black, or Keqin black. The binder may include at least one of sodium carboxymethyl cellulose, carboxymethyl cellulose, polyvinylidene fluoride, or styrene-butadiene rubber.

A mass of the negative electrode material may account for 80% to 99.5% of a total weight of the coating, for example, 80%, 81%, 82%, 83%, 84%, 85%, 86%, 87%, 88%, 89%, 90%, 91%, 92%, 93%, 94%, 95%, 96%, 97%, 98%, 99%, or 99.5%.

In an example, the mass of the negative electrode material accounts for 95% to 98.5% of the total weight of the coating.

In an example, the mass of the negative electrode material accounts for 96.2% to 97.4% of the total weight of the coating.

Based on the total weight of the coating, a content of the negative electrode material may range from 80 wt % to 99.5 wt % (for example, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, or 99.9 wt %), and a content of the conductive agent may range from 0.2 wt % to 10 wt % (for example, 10 wt %, 9 wt %, 8 wt %, 7 wt %, 6 wt %, 5 wt %, 4 wt %, 3 wt %, 2 wt %, 1 wt %, 0.5 wt %, or 0.2 wt %), and a content of the binder may range from 0.2 wt % to 10 wt % (for example, 10 wt %, 9 wt %, 8 wt %, 7 wt %, 6 wt %, 5 wt %, 4 wt %, 3 wt %, 2 wt %, 1 wt %, 0.5 wt %, or 0.2 wt %).

In an example, based on the total weight of the coating, the content of the negative electrode material ranges from 95 wt % to 98.5 wt %, the content of the conductive agent ranges from 0.5 wt % to 2.5 wt %, and the content of the binder ranges from 0.5 wt % to 2.5 wt %.

In an example, based on the total weight of the coating, the content of the negative electrode material ranges from 96.2 wt % to 97.4 wt %, the content of the conductive agent ranges from 1.3 wt % to 1.9 wt %, and the content of the binder ranges from 1.3 wt % to 1.9 wt %.

A third aspect of the present disclosure provides a battery, and the battery includes the negative electrode material according to the first aspect of the present disclosure and/or the electrode plate according to the second aspect of the present disclosure.

Components (for example, a positive electrode plate, a separator, an electrolyte solution, and the like) of the battery other than the negative electrode plate may all be conventional options in the art.

In an example, the battery further includes a positive electrode plate. The positive electrode plate includes a positive electrode current collector and a positive electrode active material layer coated on a surface of at least one side of the positive electrode current collector; and the positive electrode active material layer includes a positive electrode active material.

The positive electrode active material may be a conventional option in the art, for example, the positive electrode active material is selected from at least one of lithium cobalt oxide (LCO), nickel cobalt manganese ternary material (NCM), nickel cobalt aluminum ternary material (NCA), nickel cobalt manganese aluminum quaternary material (NCMA), lithium ferrous phosphate (LFP), lithium manganese phosphate (LMP), lithium vanadium phosphate (LVP), lithium manganate oxide (LMO), lithium nickel oxide, lithium manganese oxide, a lithium-rich manganese-base material, or lithium manganese iron phosphate.

The positive electrode active material further includes a doped and/or coated positive electrode active material. The positive electrode active material includes at least one of LCO, NCM, NCA, NCMA, LFP, LMP, LVP, LMO, lithium nickel oxide, lithium manganese oxide, a lithium-rich manganese-base material, or lithium manganese iron phosphate.

The battery may be assembled in a conventional manner in the art.

The battery may be a liquid electrolyte solution battery, a semi-solid-state battery, or an all-solid-state battery.

The battery of the present disclosure not only can keep the negative electrode material in stable interface contact with the separator or keep the negative electrode material with a solid electrolyte in the charging and discharging process, but also has excellent charge-discharge cycling stability and capacity performance.

The following describes the present disclosure in detail by using embodiments. The embodiments described in the present disclosure are merely some, but not all of the embodiments of the present disclosure. All other embodiments obtained by a person of ordinary skill in the art based on the embodiments of the present disclosure without creative efforts fall within the protection scope of the present disclosure.

In the following embodiments, the materials used are both commercially available and analytically pure without special description.

The following embodiments are used to illustrate the negative electrode plate of the present disclosure.

### Example 1

(1) Preparation of an MOF@ carbon composite material.

10 mg of graphene oxide, 0.12 g of NH₄VO₃ (ammonium metavanadate), 0.33 g of H₂BDC (terephthalic acid) and 7 mL of DMF (N,N-dimethylformamide) were dispersed in 50 mL of deionized water and stirred for 30 minutes, then transferred to a 100 mL reactor, placed in an air-blast drying oven, kept at 140° C. for 12 hours, separated and dried to obtain MIL-47(V)@ graphene oxide, where a content of the graphene oxide in the MIL-47(V)@ graphene oxide was 3 wt %, a content of the MIL-47(V) in the MIL-47(V)@ graphene oxide was 97 wt %, a median particle size Dv50 of the MIL-47(V)@ graphene oxide was 200 nm, and a volume change rate of the MIL-47(V) was 40%, where FIG. 5 was a schematic diagram of a preparation method of the MIL-47(V)@ graphene oxide obtained in Example 1.

### (2) Preparation of a Negative Electrode Plate.

The MIL-47(V)@ graphene oxide obtained in the step (1) and nano-silicon monoxide (with a median particle size Dv50 of 200 nm) were mixed to obtain a negative electrode material, and then conductive carbon black (Super P), carboxymethyl cellulose (CMC) and styrene-butadiene rubber (SBR) were added, where a mass ratio of the MIL-47(V)@ graphene oxide to the nano-silicon monoxide, the conductive carbon black, the carboxymethyl cellulose and the styrene-butadiene rubber was 19.3:77.5:1.6:0.8:0 8. Deionized water was added to obtain a negative electrode material slurry with a solid content of 45%; the negative electrode material slurry was coated on two side surfaces of a copper foil, dried in a 60° C. vacuum oven, and then rolled and sliced to obtain the negative electrode plate, where a mass proportion of the metal V in the negative electrode material was 4.1%; a ratio of a mass proportion of the MIL-47(V) in the negative electrode material to a mass proportion of the nano-silicon monoxide in the negative electrode material was 1:4.1; and a median particle size Dv50 of the negative electrode material was 205 nm.

### Example 2

### (1) Preparation of an MOF@ Carbon Composite Material.

17 mg of graphene oxide, 1.5 g of NH₂-BDC (2-aminoterephthalic acid), and 3.1 g of Al(NO₃)₃·9H₂O (aluminum nitrate nonahydrate) were dispersed in 23 mL of deionized water and stirred for 30 minutes, then transferred to a 50 mL reactor, placed in an air-blast drying oven, kept at 150° C. for 5 hours, filtered and separated, and then refluxed at 150° C. in DMF (N,N-dimethylformamide) for 8 hours to obtain NH₂-MIL-53(Al)@ graphene oxide, where a content of the graphene oxide in the NH₂-MIL-53(Al)@ graphene oxide was 1 wt %, a content of the NH₂-MIL-53(Al) in the NH₂-MIL-53(Al)@ graphene oxide was 99 wt %, a median particle size Dv50 of the NH₂-MIL-53(Al)@ graphene oxide was 100 nm, and a volume change rate of the NH₂-MIL-53(Al) was 27%.

### (2) Preparation of a Negative Electrode Plate.

The NH₂-MIL-53(Al)@ graphene oxide obtained in the step (1) and nano-silicon monoxide (with a median particle size Dv50 of 100 nm) were mixed to obtain a negative electrode material, and then conductive carbon black (Super P), carboxymethyl cellulose (CMC) and styrene-butadiene rubber (SBR) were added, where a mass ratio of the NH₂-MIL-53(Al)@ graphene oxide to the nano-silicon monoxide, the conductive carbon black, the carboxymethyl cellulose and the styrene-butadiene rubber was 19.2:78:1.4:0.7:0.7. Deionized water was added to obtain a negative electrode material slurry with a solid content of 45%; the negative electrode material slurry was coated on two side surfaces of a copper foil, dried in a 60° C. vacuum oven, and then rolled and sliced to obtain the negative electrode plate, where a mass proportion of the metal Al in the negative electrode material was 2.3%; a ratio of a mass proportion of the NH₂-MIL-53(Al) in the negative electrode material to a mass proportion of the nano-silicon monoxide in the negative electrode material was 1:4.1; and a median particle size Dv50 of the negative electrode material was 102 nm.

### Example 3

### (1) Preparation of an MOF@ Carbon Composite Material.

20 mg of graphene oxide, 0.26 g of H₂BPDC (biphenyl-4,4′-dicarboxylic acid), and 0.52 g of Al(NO₃) 3.9H₂O (aluminum nitrate nonahydrate) were dispersed in 30 mL of DMF (N,N-dimethylformamide) and stirred for 40 minutes, then transferred to a 50 mL reactor, placed in an air-blast drying oven, kept at 120° C. for 24 hours, filtered and separated, and then dried to obtain DUT-5(Al)@ graphene oxide, where a content of the graphene oxide in the DUT-5(Al)@ graphene oxide was 10 wt %, a content of the DUT-5(Al) in the DUT-5(Al)@ graphene oxide was 90 wt %, a median particle size Dv50 of the DUT-5(Al)@ graphene oxide was 400 nm, and a volume change rate of the DUT-5(Al) was 59%.

### (2) Preparation of a Negative Electrode Plate.

The DUT-5(Al)@ graphene oxide obtained in the step (1) and nano-silicon monoxide (with a median particle size Dv50 of 400 nm) were mixed to obtain a negative electrode material, and then conductive carbon black (Super P), carboxymethyl cellulose (CMC) and styrene-butadiene rubber (SBR) were added, where a mass ratio of the DUT-5(Al)@ graphene oxide to the nano-silicon monoxide, the conductive carbon black, the carboxymethyl cellulose and the styrene-butadiene rubber was 19.4:77:1.8:0.9:0.9. Deionized water was added to obtain a negative electrode material slurry with a solid content of 45%; the negative electrode material slurry was coated on two side surfaces of a copper foil, dried in a 60° C. vacuum oven, and then rolled and sliced to obtain the negative electrode plate, where a mass proportion of the metal Al in the negative electrode material was 1.7%; a ratio of a mass proportion of the DUT-5(Al) in the negative electrode material to a mass proportion of the nano-silicon monoxide in the negative electrode material was 1:4.4; and a median particle size Dv50 of the negative electrode material was 400 nm.

### Example 4

This example group was used to illustrate effects brought by change of the MOF on the negative electrode material and the negative electrode plate.

For this example group, reference was made to Example 1, except that the MOF was changed, specifically:

Example 4a: (1) 24 mg of graphene oxide, 1.8 g of Co (CF₃SO₃)₂, and 0.9 g of H₂BDP (1,4-Di (1H-pyrazol-4-yl) benzene) were dispersed in 30 mL of DMF (N,N-dimethylformamide) and stirred for 30 minutes, then transferred to a 50 mL reactor, placed in an air-blast drying oven, kept at 150° C. for 6 days, and then separated and dried to obtain Co(BDP)@ graphene oxide, where a content of the graphene oxide in the Co(BDP)@ graphene oxide was 3 wt %, a content of the Co(BDP) in the Co(BDP)@ graphene oxide was 97 wt %, a median particle size Dv50 of the Co(BDP)@ graphene oxide was 200 nm, and a volume change rate of the Co(BDP) was 21%, where a mass proportion of the metal Co in the negative electrode material was 4.1%; and a median particle size Dv50 of the negative electrode material was 200 nm.

Example 4b: (1) 75 mg of graphene oxide, 2.1 g of Zn (NO₃)₂·6H₂O (zinc nitrate hexahydrate), 1.1 g of H₄BTDC (4,4′-Carbonyldiphthalic acid), and 1.1 g of bpy (4,4′-Dipyridyl) were dispersed in 70 mL of deionized water and stirred for 30 minutes, then transferred to a 100 mL reactor, placed in an air-blast drying oven, kept at 160° C. for 4 days, and then separated and dried to obtain Zn₂(btdc)₂(bpy)@ graphene oxide, where a content of the graphene oxide in the Zn₂(btdc)₂(bpy)@ graphene oxide was 3 wt %, a content of the Zn₂(btdc)₂(bpy) in the Zn₂(btdc)₂(bpy)@ graphene oxide was 97 wt %, a median particle size Dv50 of the Zn₂(btdc)₂(bpy)@ graphene oxide was 400 nm, and a volume change rate of the Zn₂(btdc)₂(bpy) was 36%, where a mass proportion of the metal Zn in the negative electrode material was 2.4%; and a median particle size Dv50 of the negative electrode material was 319 nm.

Example 4c: (1) 30 mg of graphene oxide, 3.2 g of Zn (NO₃)₂·6H₂O (zinc nitrate hexahydrate), 1.6 g of H₂BDC (terephthalic acid), and 0.6 g of DABCO (1,4-Diazabicyclo [2.2.2] octane) were dispersed in 120 mL of DMF (N,N-dimethylformamide) and stirred for 30 minutes, then transferred to a 250 mL reactor, placed in an air-blast drying oven, kept at 140° C. for 48 hours, and then separated and dried to obtain Zn₂(1,4-bdc)₂(dabco)@ graphene oxide, where a content of the graphene oxide in the Zn₂(1,4-bdc)₂(dabco)@ graphene oxide was 3 wt %, a content of the Zn₂(1,4-bdc)₂(dabco) in the Zn₂(1,4-bdc)₂(dabco)@ graphene oxide was 97 wt %, a median particle size Dv50 of the Zn₂(1,4-bdc)₂(dabco)@ graphene oxide was 200 nm, and a volume change rate of the Zn₂(1,4-bdc)₂(dabco) was 45%, where a mass proportion of the metal Zn in the negative electrode material was 3.5%; and a median particle size Dv50 of the negative electrode material was 201 nm.

### Example 5

This example group was used to illustrate effects brought by change of the carbon material.

For this example group, reference was made to Example 1, except that the carbon material was changed, specifically:

Example 5a: a single-walled carbon nanotube with equal mass was used to replace the graphene oxide, and a median particle size Dv50 of the negative electrode material was 207 nm.

Example 5b: a multi-walled carbon nanotube with equal mass was used to replace the graphene oxide, and a median particle size Dv50 of the negative electrode material was 313 nm.

Example 5c: carbon black with equal mass was used to replace the graphene oxide, and a median particle size Dv50 of the negative electrode material was 227 nm.

### Example 6

This example group was used to illustrate effects brought by change of “the ratio of the mass proportion of the MOF in the negative electrode material to the mass proportion of the nano-silicon monoxide in the negative electrode material”.

For this example group, reference was made to Example 1, except that “the ratio of the mass proportion of the MOF in the negative electrode material to the mass proportion of the nano-silicon monoxide in the negative electrode material” was changed, specifically:

Example 6a: the MIL-47(V)@ graphene oxide obtained in the step (1) and nano-silicon monoxide (with a particle size of 200 nm) were mixed to obtain a negative electrode material, and then conductive carbon black (Super P), carboxymethyl cellulose (CMC) and styrene-butadiene rubber (SBR) were added, where a mass ratio of the MIL-47(V)@ graphene oxide to the nano-silicon monoxide, the conductive carbon black, the carboxymethyl cellulose and the styrene-butadiene rubber was 16:79:2.5:1.2:1.3, where a mass proportion of the metal V in the negative electrode material was 3.4%; and a ratio of a mass proportion of the MIL-47(V) in the negative electrode material to a mass proportion of the nano-silicon monoxide in the negative electrode material was 1:5.1.

Example 6b: the MIL-47(V)@ graphene oxide obtained in the step (1) and nano-silicon monoxide (with a particle size of 200 nm) were mixed to obtain a negative electrode material, and then conductive carbon black (Super P), carboxymethyl cellulose (CMC) and styrene-butadiene rubber (SBR) were added, where a mass ratio of the MIL-47(V)@ graphene oxide to the nano-silicon monoxide, the conductive carbon black, the carboxymethyl cellulose and the styrene-butadiene rubber was 20.5:64:8:3.5:4, where a mass proportion of the metal V in the negative electrode material was 4.4%; and a ratio of a mass proportion of the MIL-47(V) in the negative electrode material to a mass proportion of the nano-silicon monoxide in the negative electrode material was 1:3.2.

### Example 7

This example group was used to illustrate whether the organic ligand of the MOF had effects brought by a benzene ring.

For this example group, reference was made to Example 1, except that the MOF was changed, specifically: (1) preparation of an MOF@ carbon composite material.

10 mg of graphene oxide, 2.94 g of AlCl₃·6H₂O (aluminum chloride hexahydrate), and 1.68 g of C₄H₄O₄ (fumaric acid) were dispersed in 60 mL of DMF (N,N-dimethylformamide), then transferred to a 100 mL reactor, placed in an air-blast drying oven, kept at 130° C. for 4 days, and then separated and dried to obtain A520@ graphene oxide, where a content of the graphene oxide in the A520@ graphene oxide was 3 wt %, a content of the A520 in the A520@ graphene oxide was 97 wt %, a median particle size Dv50 of the A520@ graphene oxide was 200 nm, and a volume change rate of the A520 was 40%, where a mass proportion of the metal Al in the negative electrode material was 3.2%.

### Comparative Example 1

For this example group, reference was made to Example 1, except that the step (1) was different, specifically:
(1) Preparation of a composite material: 3 mL of methanol, 0.05 g of nano-silicon monoxide particles, 0.26 g of H₂BPDC (biphenyl-4,4′-dicarboxylic acid), and 0.52 g of Al(NO₃)₃·9H₂O (aluminum nitrate nonahydrate) were dispersed in 27 mL of DMF (N,N-dimethylformamide) and stirred for 40 minutes, then transferred to a 50 mL reactor, placed in an air-blast drying oven, kept at 120° C. for 24 hours, filtered and separated, and then carbonized under an inert gas for 3 hours, where a carbonization temperature was 800° C. and a heating rate was 1° C./min.

### Comparative Example 2

For this example group, reference was made to Example 1, except that the step (1) was different, specifically:
(1) Preparation of a composite material: 30 mg of graphene oxide, 0.4 g of ZrCl4 (zirconium tetrafluoride), and 0.28 g of H₂BDC (terephthalic acid) were dispersed in 60 mL of DMF (N,N-dimethylformamide) and stirred for 30 minutes, then transferred to a 100 mL reactor, placed in an air-blast drying oven, kept at 120° C. for 24 hours, filtered and separated to obtain UiO-66@ graphene oxide.

### Capacity Retention Rate Test

The negative electrode plates and the positive electrode plates (metal lithium) prepared in the examples and comparative examples were assembled into button batteries in an argon atmosphere glove box. Performing an electrochemical charge and discharge performance test on the button batteries, and the specific test method was as follows.

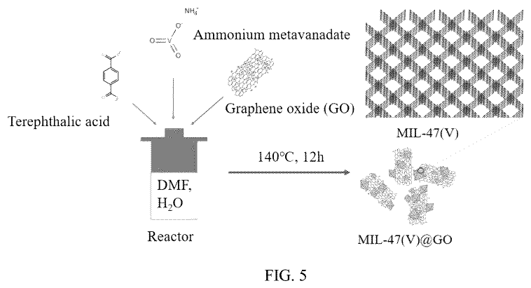

At a current density of 0.5 Ag-1 and a test voltage range of 0.01 V to 3.0 V, the cycling capacity retention rate was tested, and the test results were recorded in Table 1. Moreover, a change curve of the capacity retention rates of the batteries prepared from the negative plates obtained in Example 1 and Comparative Example 2 with the number of cycles was shown in FIG. 4.

TABLE 1

| | Capacity retention rate | Capacity after 100 |
|---|---|---|
| | after 100 cycles (%) | cycles (mAh/g) |
| Example 1 | 95.5 | 1320.7 |
| Example 2 | 91.7 | 1049.1 |
| Example 3 | 93.2 | 1208.9 |
| Example 4a | 91.3 | 1271.2 |
| Example 4b | 91.6 | 1149.5 |
| Example 4c | 92.9 | 1204.1 |
| Example 5a | 94.2 | 1301.3 |
| Example 5b | 94.4 | 1293.5 |
| Example 5c | 92.7 | 1249.8 |
| Example 6a | 86.7 | 1341.2 |
| Example 6b | 98.2 | 1075.7 |
| Example 7 | 94.3 | 1137.2 |
| Comparative Example 1 | 81.2 | 1089.2 |
| Comparative Example 2 | 74.1 | 761.9 |

FIG. 2 is an XRD pattern of the MIL-47(V)@ graphene oxide obtained in Example 1. It may be learned from the figure that characteristic peaks of the MIL-47(V) occur at 2 Theta of 8.5°, 16.8° and 25°, and characteristic peak of the graphene oxide occurs at 2 Theta of about 9°, indicating that the MIL-47(V)@ graphene oxide composite material is prepared in Example 1.

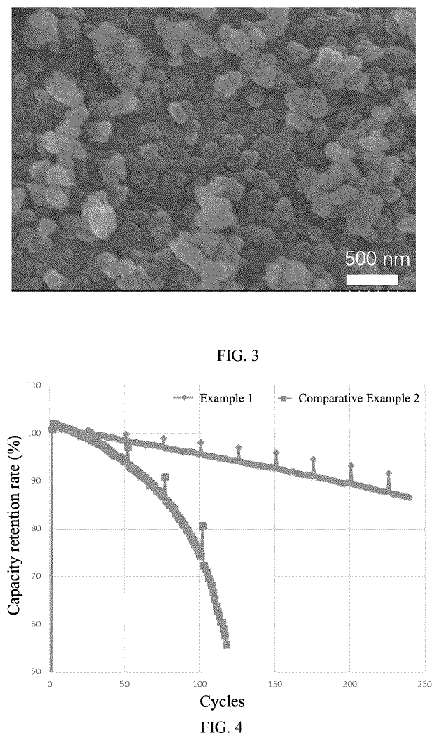

FIG. 3 is an SEM image of the MIL-47(V)@ graphene oxide obtained in Example 1. It may be learned from the figure that the MIL-47(V)@ graphene oxide is spherical particles with a particle size of about 200 nm, and the particle size is uniform, which is close to a particle size of the nano-silicon monoxide, and can improve blending uniformity.

FIG. 4 is a comparison diagram of a cycling capacity retention rate of a battery prepared by a negative electrode plate obtained in Example 1 and a capacity retention rate of a battery prepared by a negative electrode plate obtained in Comparative Example 2. It may be learned from the figure that the cycling capacity retention rate of Example 1 is significantly higher than that of Comparative Example 2.

It may be learned from Table 1 that compared with the comparative examples, the battery prepared from the negative electrode material of the present disclosure has a significantly improved capacity retention rate.

The foregoing describes in detail a preferred implementation of the present disclosure. However, the present disclosure is not limited thereto. Within the scope of the technical concepts of the present disclosure, various simple variations may be implemented to the technical solutions of the present disclosure, including combinations of technical features in any other suitable manner. These simple variations and combinations shall also be considered as the disclosure of the present disclosure and shall fall within the protection scope of the present disclosure.

What is claimed is:

1. A negative electrode material, comprising a Metal-organic framework material (MOF)@ carbon composite material and a silicon-based material.

2. The negative electrode material according to claim 1, wherein the MOF@ carbon composite material comprises an MOF-coated carbon material and/or an MOF-doped carbon material.

3. The negative electrode material according to claim 1, wherein an MOF in the MOF@ carbon composite material has a flexible framework structure.

4. The negative electrode material according to claim 1, wherein an MOF in the MOF@ carbon composite material is formed by assembling an organic ligand and a metal ion by means of a chemical self-assembly process;
the metal ion is selected from at least one of Fe³⁺, Al³⁺, Co²⁺, V⁵⁺, Ti⁴⁺, Zn²⁺, Cu²⁺, Cr³⁺, Mn²⁺, or Ni²⁺; and
the organic ligand is selected from at least one of terephthalic acid, 2-aminoterephthalic acid, biphenyl-4,4′-dicarboxylic acid, 1,4-Di (1H-pyrazol-4-yl) benzene, 4,4′-Dipyridyl, 4,4′-Carbonyldiphthalic acid, or 1,4-Diazabicyclo [2.2.2] octane.

5. The negative electrode material according to claim 1, wherein an MOF in the MOF@ carbon composite material comprises a metal element, and the metal element is selected from at least one of Fe, Al, Co, V, Ti, Zn, Cu, Cr, Mn, or Ni; and/or
a mass of the metal element accounts for 0.72% to 7.8% of a total mass of the negative electrode material.

6. The positive electrode material according to claim 5, wherein the mass of the metal element accounts for 0.8% to 6.2% of the total mass of the negative electrode material.

7. The negative electrode material according to claim 4, wherein the organic ligand contains a benzene ring.

8. The negative electrode material according to claim 7, wherein the organic ligand contains a terephthalic acid.

9. The negative electrode material according to claim 1, wherein an MOF in the MOF@ carbon composite material is selected from at least one of MIL-47(V), NH₂-MIL-53(Al), DUT-5(Al), Co(BDP), Zn₂(btdc)₂(bpy), or Zn₂(1,4-bdc)₂(dabco).

10. The negative electrode material according to claim 9, wherein the MOF in the MOF@ carbon composite material is a combination of MIL-47(V) with at least one of NH₂-MIL-53(Al), DUT-5(Al), Co(BDP), Zn₂(btdc)₂(bpy), or Zn₂(1,4-bdc)₂(dabco); or
the MOF in the MOF@ carbon composite material is MIL-47(V).

11. The negative electrode material according to claim 1, wherein in an X-ray diffraction (XRD) pattern of an MOF in the MOF@ carbon composite material, characteristic peaks occur at 8.2° to 8.8°, 16.3° to 17.3°, and 24.5° to 25.5°.

12. The negative electrode material according to claim 1, wherein a volume change rate of an MOF in the MOF@ carbon composite material ranges from 20% to 60%.

13. The negative electrode material according to claim 1, wherein the silicon-based material comprises at least one of silicon, silicon carbon, or SiOₓ, and 0<x<2.

14. The negative electrode material according to claim 1, wherein a median particle size Dv50 of the MOF@ carbon composite material ranges from 100 nm to 400 nm; and/or
a median particle size Dv50 of the silicon-based material ranges from 100 nm to 400 nm; and/or
a median particle size Dv50 of the negative electrode material ranges from 100 nm to 400 nm.

15. The negative electrode material according to claim 2, wherein the carbon material is selected from at least one of a graphene material, a carbon nanotube, carbon black, soft carbon, hard carbon, or graphite.

16. The negative electrode material according to claim 15, wherein the graphene material is graphene oxide; and/or
in an XRD pattern of the carbon material, characteristic peaks occur at 8.5° to 9.5°.

17. The negative electrode material according to claim 1, wherein based on a total weight of the negative electrode material, a content of the MOF@ carbon composite material ranges from 16 wt % to 26 wt %, and a content of the silicon-based material ranges from 74 wt % to 84 wt %.

18. The negative electrode material according to claim 1, wherein a ratio of a mass proportion of an MOF in the negative electrode material to a mass proportion of the silicon-based material in the negative electrode material ranges from 1:3.1 to 1:5.5.

19. A negative electrode plate, comprising the negative electrode material according to claim 1.

20. A battery, comprising the negative electrode material according to claim 1.
